(19) United States
(12) Patent Application Publication
(10) Pub. No.: US 2009/0046182 A1
(43) Pub. Date: Feb. 19, 2009

(54) PIXEL ASPECT RATIO CORRECTION USING PANCHROMATIC PIXELS

(76) Inventors: James E. Adams, JR., Rochester, NY (US); Michele O'Brien, Rochester, NY (US); John F. Hamilton, JR., Rochester, NY (US)

Correspondence Address: Frank Pincelli;Patent Legal Staff, Eastman Kodak Company, 343 State Street, Rochester, NY, 14650-2201, US

(21) Appl. No.: 11/838,318

(22) Filed: Aug. 14, 2007

(51) Int. Cl. H04N 3/14

(52) U.S. Cl. 348/273

(57) ABSTRACT

A method for forming an enhanced digital full-color image having a first pixel aspect ratio includes capturing an image using an image sensor having panchromatic pixels and color pixels corresponding to at least two color photoresponses wherein color and panchromatic pixels each have a second pixel aspect ratio different from the first pixel aspect ratio, providing from the captured image a digital high-resolution panchromatic image and changing the aspect ratio of the panchromatic pixel values from the second pixel aspect ratio to the first pixel aspect ratio to produce a digital aspect corrected high-resolution panchromatic image, providing from the captured image a digital low-resolution color difference color filter array image, providing a digital aspect corrected high-resolution color difference image from the low-resolution color difference color filter array image, and using the aspect corrected high-resolution panchromatic image and an aspect corrected high-resolution color difference image to produce the enhanced digital full-color image.

### CROSS REFERENCE TO RELATED APPLICATIONS

Reference is made to commonly assigned U.S. patent application Ser. No. 11/341,206, filed Jan. 27, 2006 (U.S. Patent Application Publication 2007/0024934) by James E. Adams, Jr. et al, entitled “Interpolation of Panchromatic and Color Pixels”, and U.S. patent application Ser. No. 11/564,451 filed Nov. 29, 2006 by James E. Adams, Jr. et al, entitled “Providing a Desired Resolution Color Image” the disclosures of which are incorporated herein.

### FIELD OF THE INVENTION

The present invention relates to forming a color image having a desired pixel aspect ratio from a panchromatic image and a color image having a different pixel aspect ratio.

### BACKGROUND OF THE INVENTION

Video cameras and digital still cameras generally employ a single image sensor with a color filter array to record a scene. This approach begins with a sparsely populated single-channel image in which the color information is encoded by the color filter array pattern. Subsequent interpolation of the neighboring pixel values permits the reconstruction of a complete three-channel, full-color image. A generally understood assumption is that this full-color image is composed of pixels values sampled on a square pixel lattice, i.e., the image pixels are square. This is important for the vast majority of image display and printing devices use square pixels for subsequent image rendering. However, requiring square pixels in the full-color image does not require the single image sensor to use square pixels. Sensors using rectangular (non-square) pixels are well known in the art. The general practice of producing a square pixel image from a rectangular pixel capture is to produce a full-color image with rectangular pixels and then, as a final step, transform the full-color image into one with square pixels. This approach is exemplified by U.S. Pat. No. 5,778,106 (Juenger et al.) See FIG. 2. A digital camera 200 equipped with a single sensor of rectangular pixels produces an RGB CFA image 202. A CFA interpolation block 204 produces a full-color image 206 from the RGB CFA image 202. A pixel aspect ratio correction block 208 produces a pixel aspect ratio corrected full-color image 210 from the full-color image 206. In this example, it can be seen that an extra operation (block 208) is required in the image processing chain in order to produce an image with square pixels (block 210) from an initial image with non-square pixels (block 202). A better solution would be to incorporate the pixel aspect ratio correction block 208 directly into the CFA interpolation block 204. A related example of this approach is taught in U.S. Pat. No. 7,092,020 (Yoshikawa). See FIG. 3. A digital camera 212 (equipped with a single sensor of square pixels) produces an RGB CFA image 214. A CFA interpolation and resizing block 216 produces a resized full-color image 218 from the RGB CFA image 214 by directly computing a digitally zoomed (enlarged) full-color image without dividing the operation into two separate steps (interpolation then resizing) or producing a corresponding intermediate image.

Under low-light imaging situations, it is advantageous to have one or more of the pixels in the color filter array unfiltered, i.e. white or panchromatic in spectral sensitivity. These panchromatic pixels have the highest light sensitivity capability of the capture system. Employing panchromatic pixels represents a tradeoff in the capture system between light sensitivity and color spatial resolution. To this end, many four-color color filter array systems have been described. U.S. Pat. No. 6,529,239 (Dyck et al.) teaches a green-cyan-yellow-white pattern that is arranged as a 2×2 block that is tessellated over the surface of the sensor. U.S. Pat. No. 6,757,012 (Hubina et al.) discloses both a red-green-blue-white pattern and a yellow-cyan-magenta-white pattern. In both cases, the colors are arranged in a 2×2 block that is tessellated over the surface of the imager. The difficulty with such systems is that only one-quarter of the pixels in the color filter array have highest light sensitivity, thus limiting the overall low-light performance of the capture device.

To address the need of having more pixels with highest light sensitivity in the color filter array, U.S. Patent Application Publication No. 2003/0210332 (Frame) describes a pixel array with most of the pixels being unfiltered. Relatively few pixels are devoted to capturing color information from the scene producing a system with low color spatial resolution capability. Additionally, Frame teaches using simple linear interpolation techniques that are not responsive to or protective of high frequency color spatial details in the image.

### SUMMARY OF THE INVENTION

It is an object of the present invention to produce a digital color image having the desired pixel aspect ratio from a digital image having panchromatic and color pixels with a different pixel aspect ratio.

This object is achieved by a method of forming an enhanced digital full-color image having a first pixel aspect ratio, comprising:

(a) capturing an image using an image sensor having panchromatic pixels and color pixels corresponding to at least two color photoresponses wherein color and panchromatic pixels each have a second pixel aspect ratio different from the first pixel aspect ratio;

(b) providing from the captured image a digital high-resolution panchromatic image and changing the aspect ratio of the panchromatic pixel values from the second pixel aspect ratio to the first pixel aspect ratio to produce a digital aspect corrected high-resolution panchromatic image;

(c) providing from the captured image a digital low-resolution color difference color filter array image;

(d) providing a digital aspect corrected high-resolution color difference image from the low-resolution color difference color filter array image; and

(e) using the aspect corrected high-resolution panchromatic image and an aspect corrected high-resolution color difference image to produce the enhanced digital full-color image.

It is a feature of the present invention that images can be captured under low-light conditions with a sensor having panchromatic and color pixels with a first pixel aspect ratio and processing produces the desired pixel aspect ration in a digital color image produced from the panchromatic and colored pixels.

The present invention makes use of a color filter array with an appropriate composition of panchromatic and color pixels in order to permit the above method to provide both improved low-light sensitivity and improved color spatial resolution fidelity. The above method preserves and enhances panchromatic and color spatial details and produce a full-color, full-resolution image.

### BRIEF DESCRIPTION OF THE DRAWINGS

FIG. 1 is a perspective of a computer system including a digital camera for implementing the present invention;

FIG. 2 is a block diagram of a prior art pixel aspect ratio correction image processing chain;

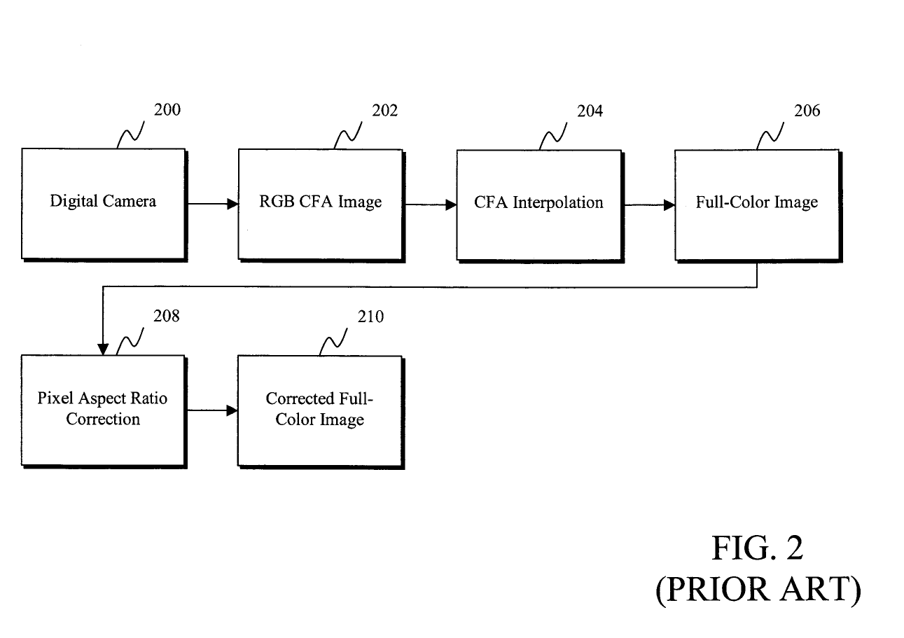

FIG. 3 is a block diagram of a prior art of a combined CFA interpolation and resizing image processing chain;

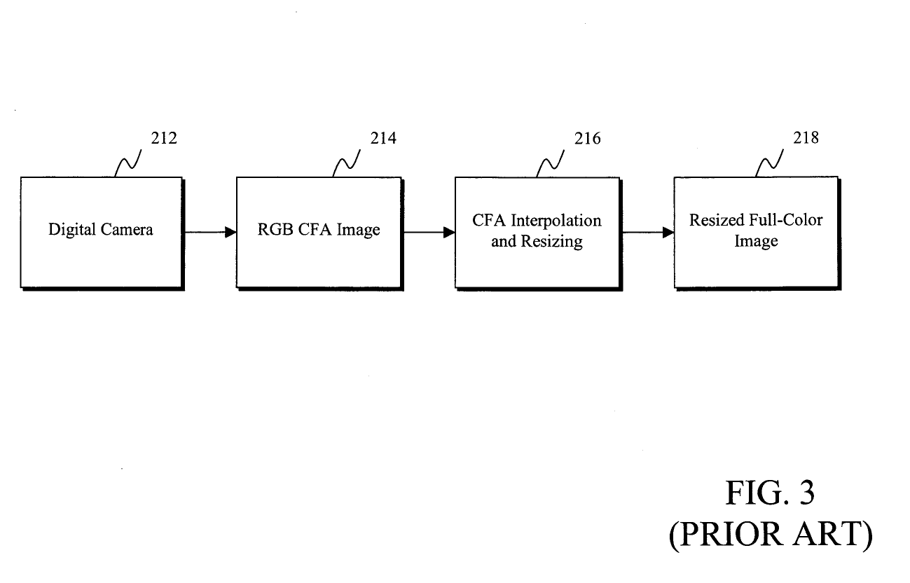

FIG. 4 is a block diagram of a preferred embodiment of the present invention;

FIG. 5A is a block diagram showing block 302 in FIG. 4 in more detail;

FIG. 5B is a block diagram showing block 302 in FIG. 4 in more detail of an alternate embodiment of the present invention;

FIG. 6A is a block diagram showing block 316 in FIG. 4 in more detail;

FIG. 6B is a block diagram showing block 316 in FIG. 4 in more detail of an alternate embodiment of the present invention;

FIG. 6C is a block diagram showing block 316 in FIG. 4 in more detail of an alternate embodiment of the present invention;

FIG. 6D is a block diagram showing block 316 in FIG. 4 in more detail of an alternate embodiment of the present invention;

FIG. 6E is a block diagram showing block 316 in FIG. 4 in more detail of an alternate embodiment of the present invention;

FIG. 6F is a block diagram showing block 316 in FIG. 4 in more detail of an alternate embodiment of the present invention;

FIG. 7A and 7B are regions of pixels used in block 316 in FIG. 6A;

FIG. 8A and 8B are regions of pixels used in block 316 in FIG. 6C;

FIG. 9A and 9B are regions of pixels used in block 316 in FIG. 6D;

FIG. 10A and 10B are regions of pixels used in block 316 in FIG. 6E; and

FIG. 11A and 11B are regions of pixels used in block 316 in FIG. 6F.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such as a personal computer. Consequently, the computer system will not be discussed in detail herein. It is also instructive to note that the images are either directly input into the computer system (for example by a digital camera) or digitized before input into the computer system (for example by scanning an original, such as a silver halide film).

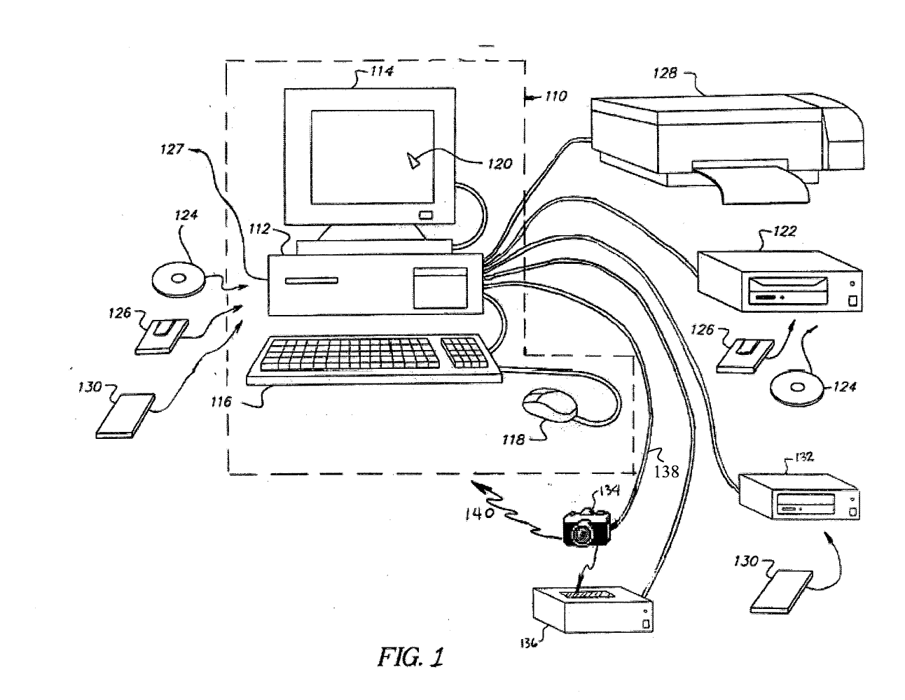

Referring to FIG. 1, there is illustrated a computer system 110 for implementing the present invention. Although the computer system 110 is shown for the purpose of illustrating a preferred embodiment, the present invention is not limited to the computer system 110 shown, but can be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by a graphical user interface. A keyboard 116 is also connected to the microprocessor based unit 112 for permitting a user to input information to the software. As an alternative to using the keyboard 116 for input, a mouse 118 can be used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a way of inputting the software programs and other information to the microprocessor based unit 112. In addition, a floppy disk 126 can also include a software program, and is inserted into the microprocessor-based unit 112 for inputting the software program. The compact disk-read only memory (CD-ROM) 124 or the floppy disk 126 can alternatively be inserted into externally located disk drive unit 122 which is connected to the microprocessor-based unit 112. Still further, the microprocessor-based unit 112 can be programmed, as is well known in the art, for storing the software program internally. The microprocessor-based unit 112 can also have a network connection 127, such as a telephone line, to an external network, such as a local area network or the Internet. A printer 128 can also be connected to the microprocessor-based unit 112 for printing a hardcopy of the output from the computer system 110.

Images can also be displayed on the display 114 via a personal computer card (PC card) 130, such as it was formerly known, a PCMCIA card (based on the specifications of the Personal Computer Memory Card International Association) which contains digitized images electronically embodied in the PC card 130. The PC card 130 is ultimately inserted into the microprocessor based unit 112 for permitting visual display of the image on the display 114. Alternatively, the PC card 130 can be inserted into an externally located PC card reader 132 connected to the microprocessor-based unit 112. Images can also be input via the compact disk-read only memory (CD-ROM) 124, the floppy disk 126, or the network connection 127. Any images stored in the PC card 130, the floppy disk 126 or the compact disk-read only memory (CD-ROM) 124, or input through the network connection 127, can have been obtained from a variety of sources, such as a digital camera (not shown) or a scanner (not shown). Images can also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the algorithm can be stored in any of the storage devices heretofore mentioned and applied to images in order to interpolate sparsely populated images.

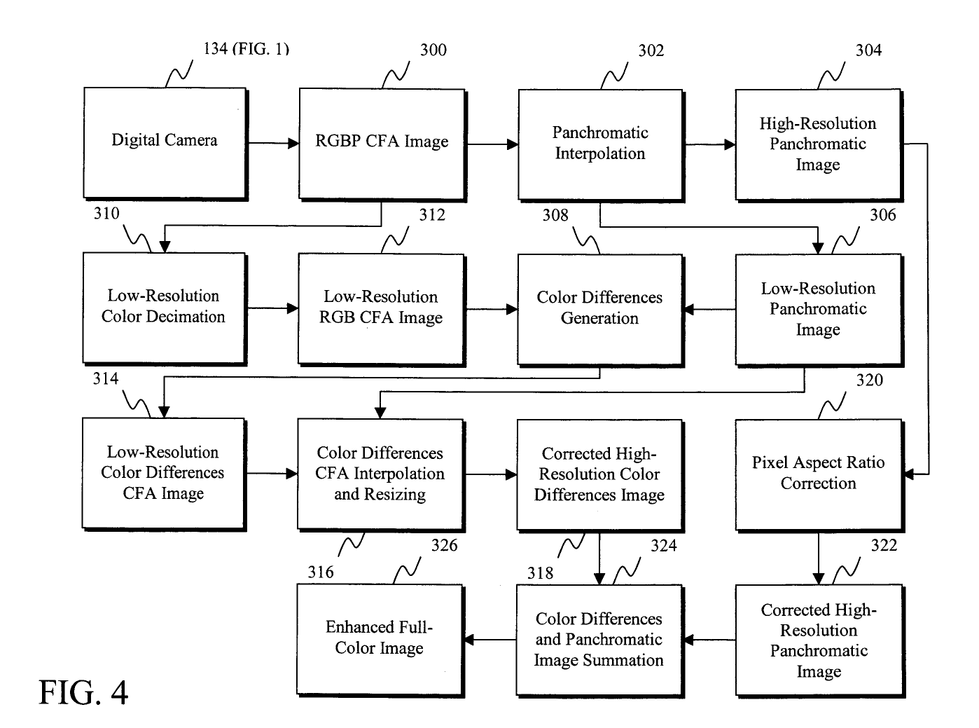

FIG. 4 is a high level diagram of a preferred embodiment. The digital camera 134 (FIG. 1) is responsible for creating an original digital red-green-blue-panchromatic (RGBP) color filter array (CFA) image 300, also referred to as the digital RGBP CFA image or the RGBP CFA image. It is noted at this point that other color channel combinations, such as cyan-magenta-yellow-panchromatic, can be used in place of red-green-blue-panchromatic in the following description. The key item is the inclusion of a panchromatic channel. This image is considered to be a sparsely sampled image because each pixel in the image contains only one pixel value of red, green, blue, or panchromatic data. A panchromatic interpolation block 302 produces a high-resolution panchromatic image 304 and a low-resolution panchromatic image 306 from the RGBP CFA image 300. At this point in the image processing chain, each color pixel location has an associated panchromatic value and either a red, green, or a blue value. The low-resolution color decimation block 310 produces a low-resolution RGB CFA image 312 from the RGBP CFA image 300. The color differences generation block 308 produces a low-resolution color differences CFA image 314 from the low-resolution RGB CFA image 312 and the low-resolution panchromatic image 306. The color differences CFA interpolation and resizing block 316 produces a corrected high-resolution color differences image 318 from the low-resolution color differences CFA image 314 and the low-resolution panchromatic image 306. The pixel aspect ratio correction block 320 produces a corrected high-resolution panchromatic image 322 from the high-resolution panchromatic image 304. Finally, the color differences and panchromatic image summation block 324 produces an enhanced full-color image 326 from the corrected high-resolution color differences image 318 and the corrected high-resolution panchromatic image 322.

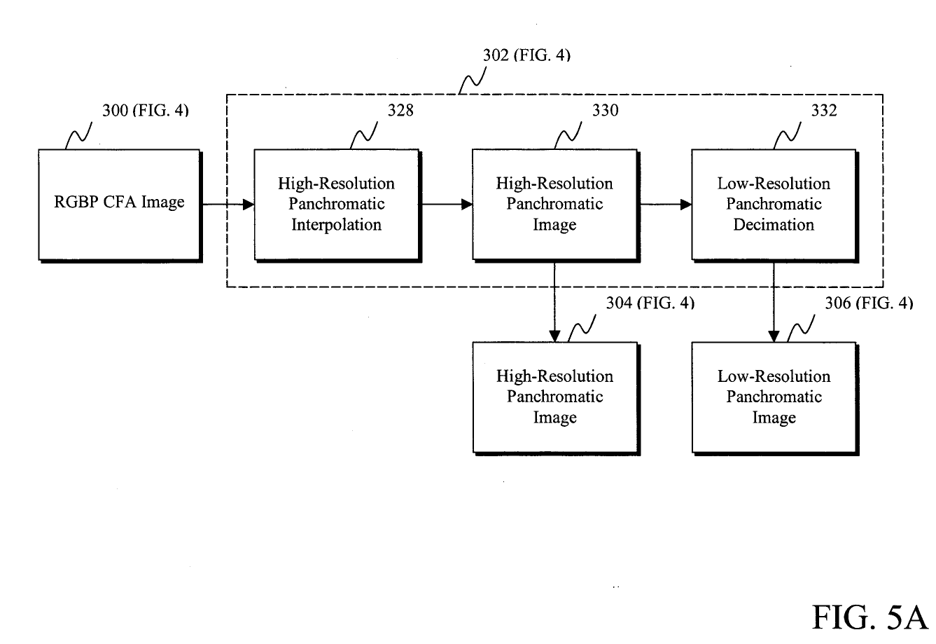

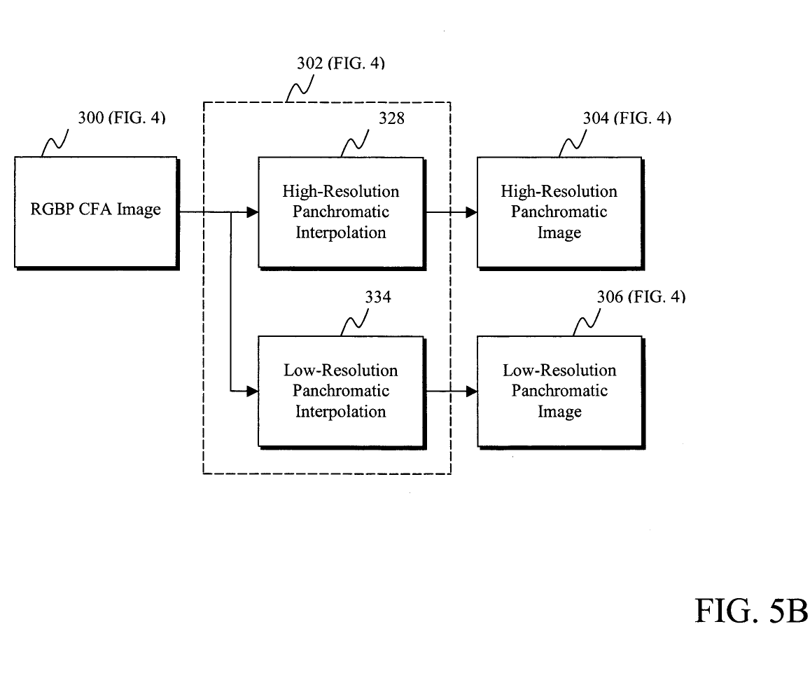

FIG. 5A is a more detailed view of block 302 (FIG. 4) of the preferred embodiment. The high-resolution panchromatic interpolation block 328 produces a high-resolution panchromatic image 330 from the RGBP CFA image 300 (FIG. 4). A copy of the high-resolution panchromatic image 330 becomes the high-resolution panchromatic image 304 (FIG. 4). The low-resolution panchromatic decimation block 332 produces the low-resolution panchromatic image 306 (FIG. 4) from the high-resolution panchromatic image 330.

In FIG. 5A, the high-resolution panchromatic interpolation block 328 and the low-resolution panchromatic decimation block 332 can be performed in any ways known to those skilled in the art. Suitable methods are taught in above-cited, commonly-assigned U.S. Patent Application Publication No. 2007/0024934 and U.S. patent application Ser. No. 11/564,451.

FIG. 5B is a more detailed view of block 302 (FIG. 4) of an alternate embodiment. The high-resolution panchromatic interpolation block 328 produces the high-resolution panchromatic image 304 (FIG. 4) from the RGBP CFA image 300 (FIG. 4). The low-resolution panchromatic interpolation block 334 produces the low-resolution panchromatic image 306 (FIG. 4) from the RGBP CFA image 300 (FIG. 4). The high-resolution panchromatic interpolation block 328 has already been discussed under FIG. 5A. The low-resolution panchromatic interpolation block 334 differs from the high-resolution panchromatic interpolation block 328 only in that the captured panchromatic pixel values are automatically discarded after the interpolation computations in order to produce a low-resolution panchromatic image of interpolated panchromatic pixel values.

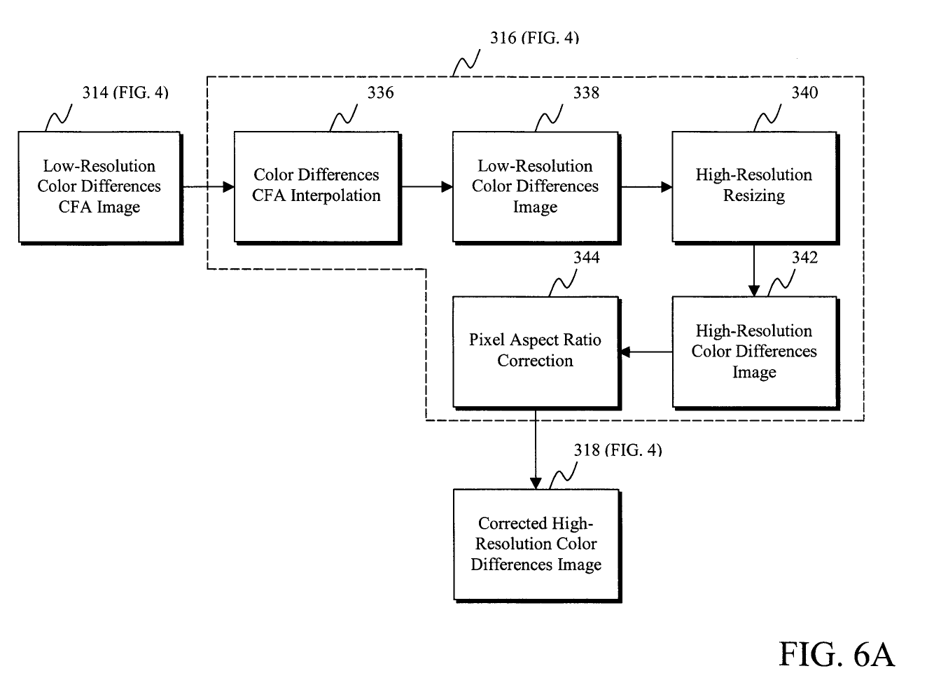

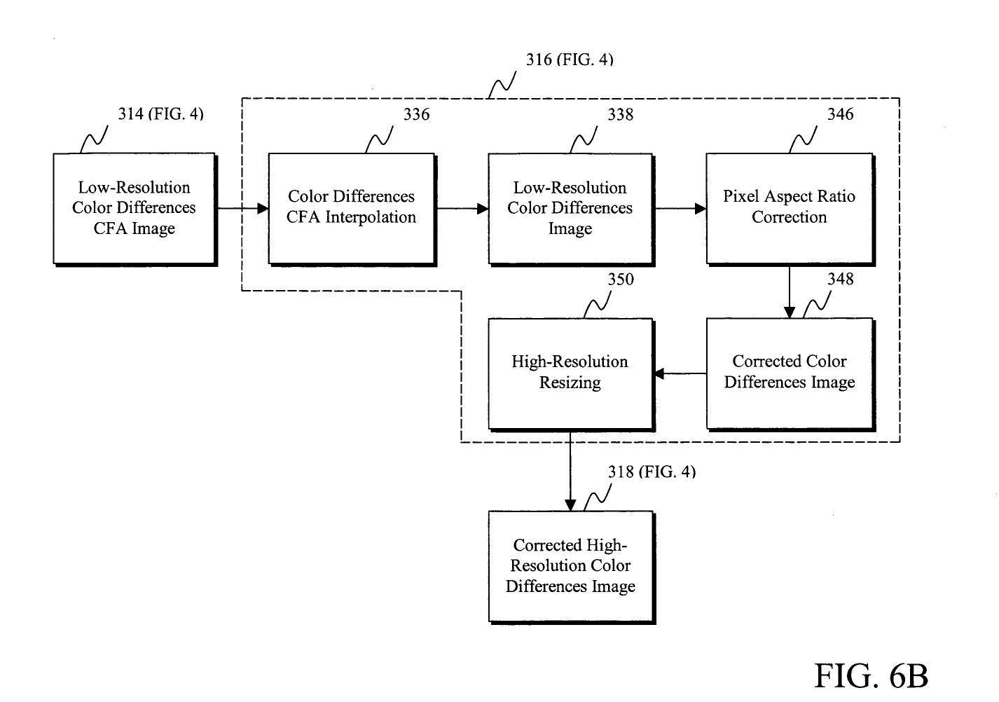

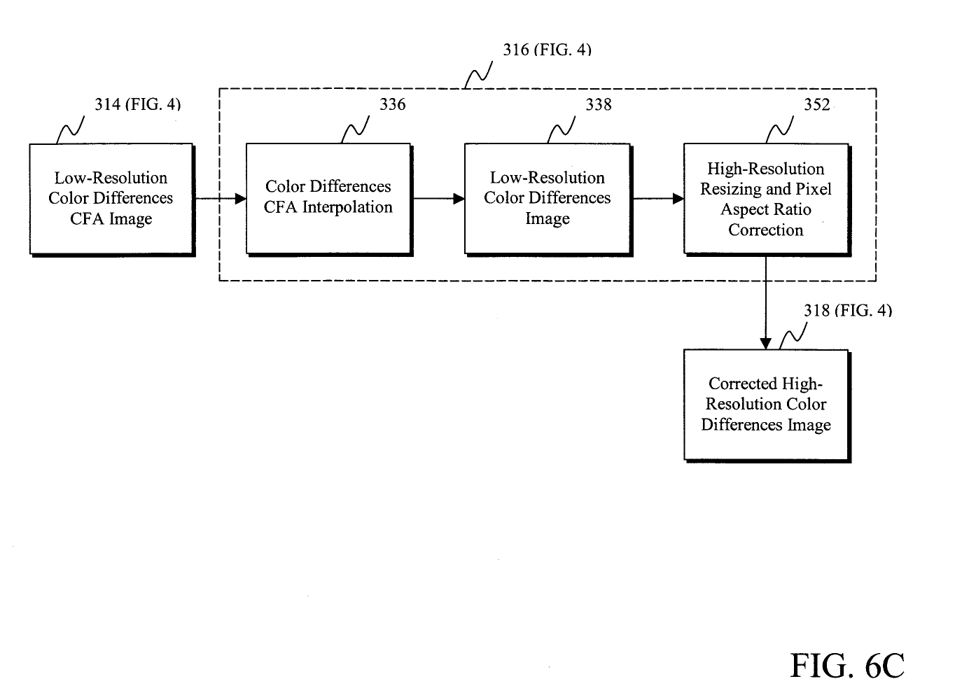

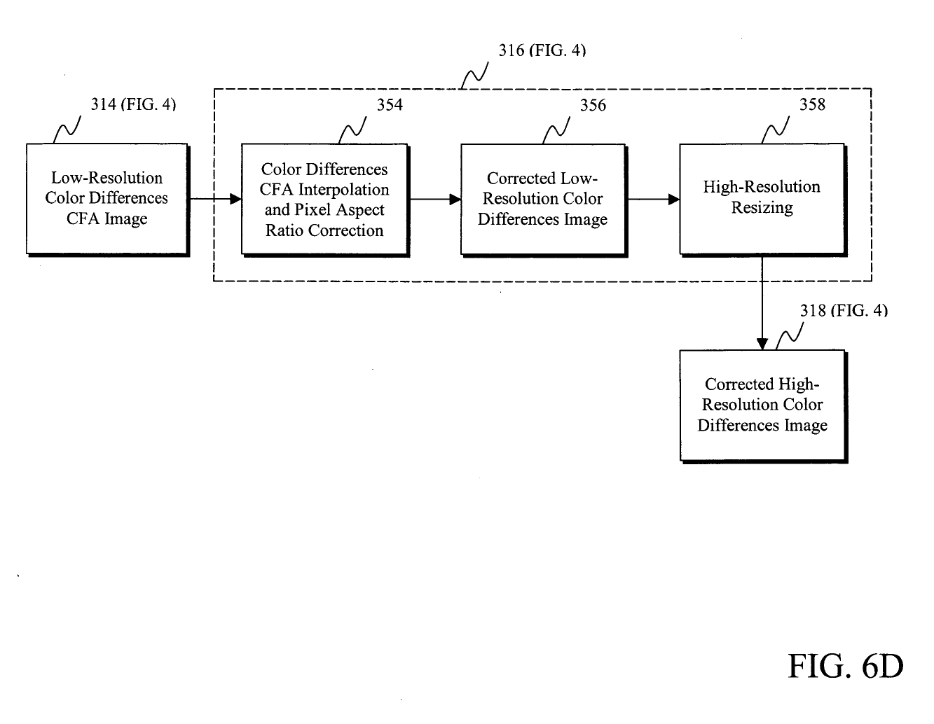

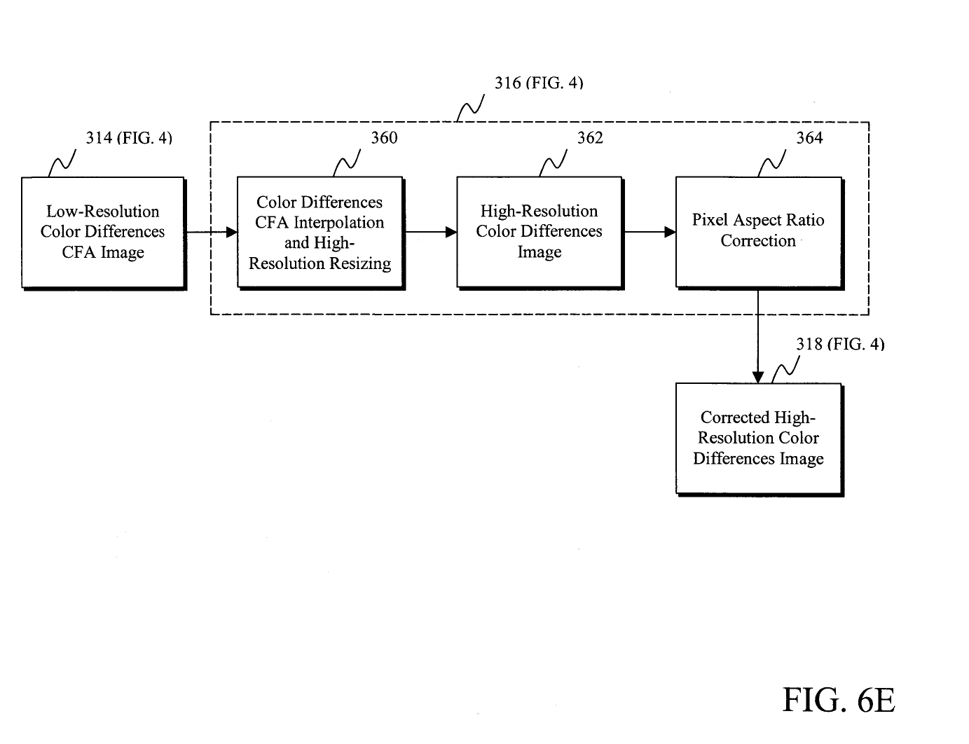

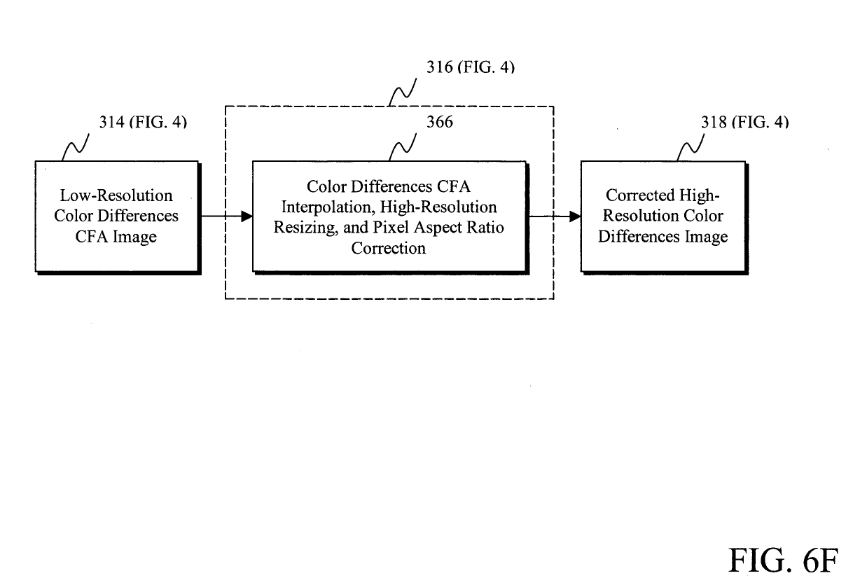

FIG. 6A is a more detailed view of block 316 (FIG. 4) of the preferred embodiment. A color differences CFA interpolation block 336 produces a low-resolution color differences image 338 from the low-resolution color differences CFA image 314 (FIG. 4). A high-resolution resizing block 340 produces a high-resolution color differences image 342 from the low-resolution color differences image 338. A pixel aspect ratio correction block 344 produces the corrected high-resolution color differences image 318 (FIG. 4) from the high-resolution color differences image 342.

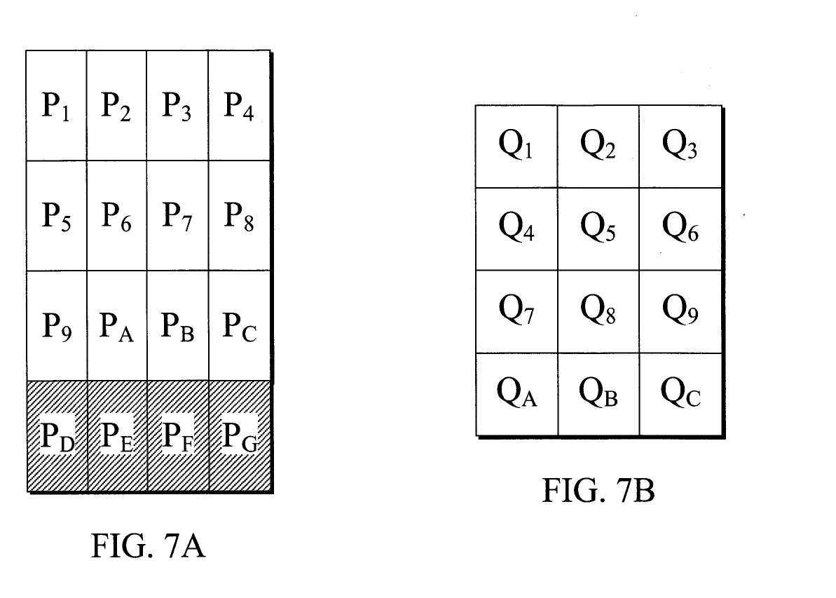

In FIG. 6A, the color differences CFA interpolation block 336 may be performed in any way known to those skilled in the art. Suitable methods are taught in above-cited, commonly-assigned U.S. Patent Application Publication No. 2007/0024934 and U.S. patent application Ser. No. 11/564,451. The high-resolution resizing block 340 is a standard digital image resizing (interpolation or resampling) operation with an appropriate method described also in commonly-assigned U.S. Patent Application Publication No. 2007/0024934. The pixel aspect ratio correction block 344 is also a standard digital image resizing operation with the notable feature that the horizontal scale factor differs from the vertical scale factor. As an example, FIG. 7B (Q₁-Q_{C}) represents the pixel aspect ratio corrected version of FIG. 7A (P₁-P_{C}). Using bilinear interpolation, the pixel aspect ratio computation would be as follows:

Q₁=P₁

Q₂=(2P₂+P₃)/3

Q₃=(P₃+2P₄)/3

Q₄=(P₁+3P₅)/4

Q₅=(2P₂+P₃+6P₆+3P₇)/12

Q₆=(P₃+2P₄+3P₇+6P₈)/12

Q₇=(P₅+(₉)/2

Q₈=(2P₆+P₇+2P_{A}+P_{B})/6

Q₉=(P₇+2P₈+P₈+2P_{C})/6

Q_{A}=(3P₉+P_{D})/4

Q_{B}=(6P_{A}+3P_{B}+2P_{E}+P_{F})/12

Q_{C}=(3P_{B}+6P_{C}+P_{F}+2P_{G})/12

It will be apparent to one skilled in the art that other methods of interpolation, such as cubic convolution interpolation, can be used in place of bilinear interpolation.

FIG. 6B is a more detailed view of block 316 (FIG. 4) of an alternate embodiment. A color differences CFA interpolation block 336 produces a low-resolution color differences image 338 from the low-resolution color differences CFA image 314 (FIG. 4). A pixel aspect ratio correction block 346 produces a corrected color differences image 348 from the low-resolution color differences image 338. A high-resolution resizing block 350 produces the corrected high-resolution color differences image 318 (FIG. 4) from the corrected color differences image 348.

In FIG. 6B, the color differences CFA interpolation block 336 is as previously described under FIG. 6A. The pixel aspect ratio correction block 346 is the same as the pixel aspect ratio correction block 344 of FIG. 6A except that block 346 operates on low-resolution data and block 344 operates on high-resolution data. The high-resolution resizing block 350 is the same as the high-resolution resizing block 340 except that block 350 operates on pixel aspect ratio corrected data and block 340 does not.

FIG. 6C is a more detailed view of block 316 (FIG. 4) of an alternate embodiment. A color differences CFA interpolation block 336 produces a low-resolution color differences image 338 from the low-resolution color differences CFA image 314 (FIG. 4). A high-resolution resizing and pixel aspect ratio correction block 352 produces the corrected high-resolution color differences image 318 (FIG. 4) from the low-resolution color differences image 338.

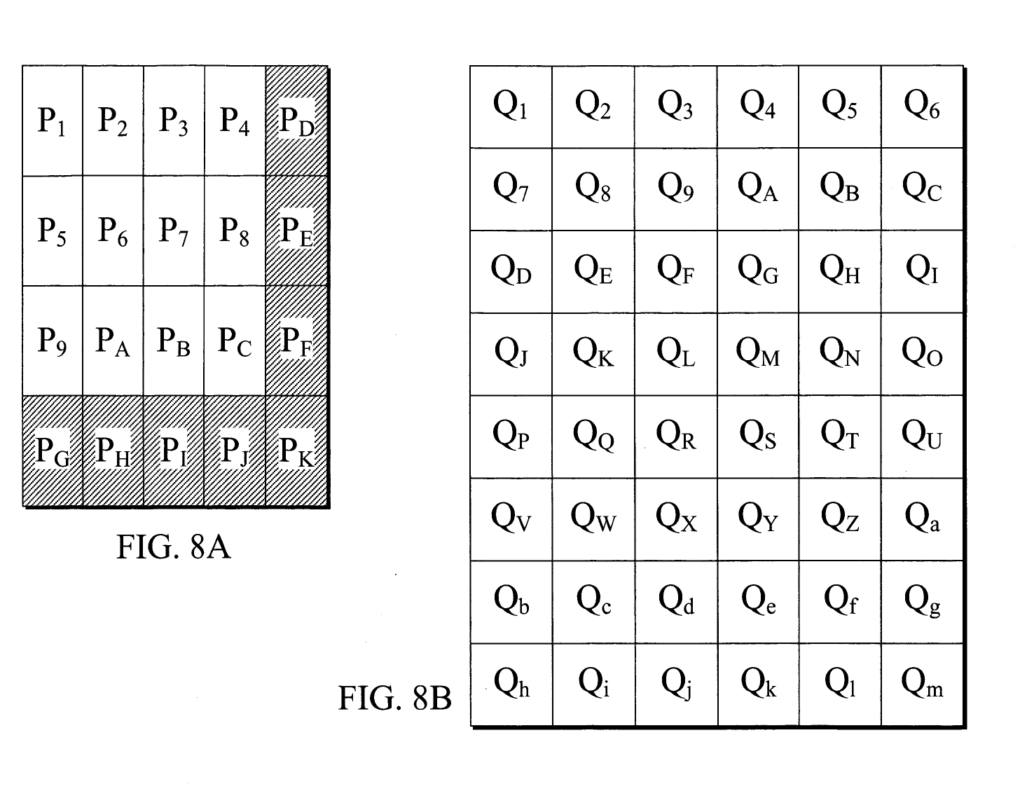

In FIG. 6C, the color differences CFA interpolation block 336 is as previously described under FIG. 6A. The high-resolution resizing and pixel aspect ratio correction block 352 performs high-resolution resizing and pixel aspect ratio correction as a single operation. Block 352 is accomplished by a standard resizing operation with different scale factors for the horizontal and vertical directions. As an example, FIG. 8B (Q₁-Qₘ) represents the high-resolution resized and pixel aspect ratio corrected version of FIG. 8A (P₁-P_{C}). Using bilinear interpolation, the pixel aspect ratio computation in part would be as follows:

Q₁=P₁

Q₂=(P₁+2P₂)/3

Q₃=(2P₂+P₃)/3

Q₇=(5P₁+3P₅)/8

Q₈=(5P₁+10P₂+3P₅+6P₆)/24

Q₉=(10P₂+5P₃+6P₆+3P₇)/24

Q_{D}=(P₁+3P₅)/4

Q_{E}=(P₁+2P₂+3P₅+6P₆)/12

Q_{F}=(2P₂+P₃+6P₆+3P₇)/6

Q_{J}=(7P₅+P₉)/8

Q_{K}=(7P₅+14P₆+P₉+2P_{A})/24

Q_{L}=(14P₆+7P₇+2P_{A}+P_{B})/24

It will be apparent to one skilled in the art how to extend these computations to produce the other values of Q in FIG. 8B. It will also be apparent to one skilled in the art that other methods of interpolation, such as cubic convolution interpolation, can be used in place of bilinear interpolation.

FIG. 6D is a more detailed view of block 316 (FIG. 4) of an alternate embodiment. A color differences CFA interpolation and pixel aspect ratio correction block 354 produces a corrected low-resolution color differences image 356 from the low-resolution color differences CFA image 314 (FIG. 4). A high-resolution resizing block 358 produces the corrected high-resolution color differences image 318 (FIG. 4) from the corrected low-resolution color differences image 356.

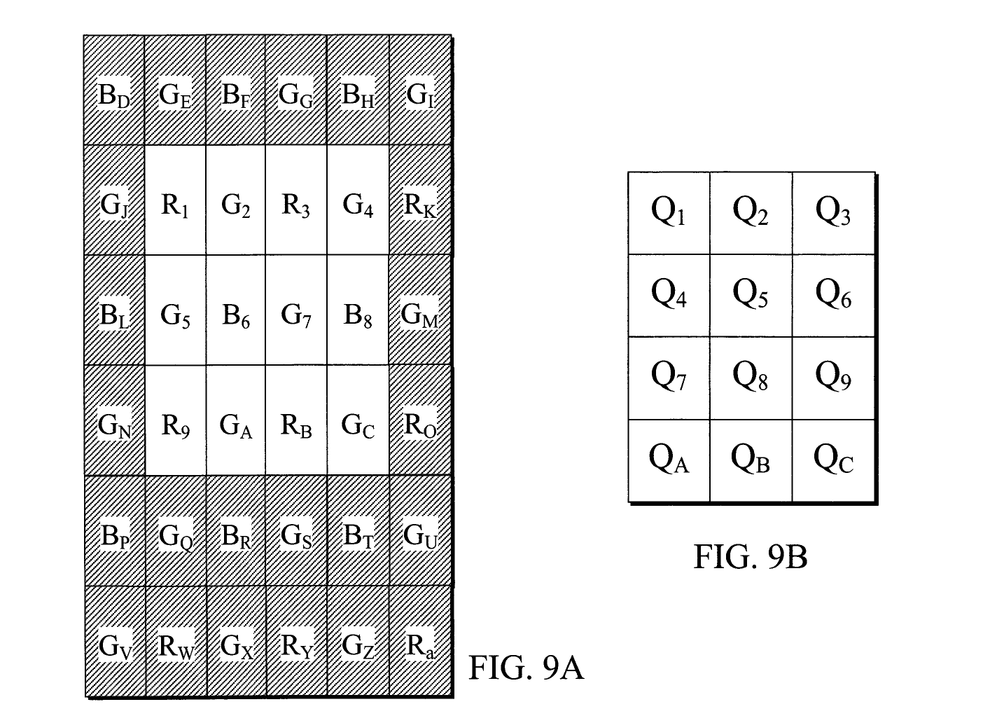

In FIG. 6D, the high-resolution resizing block 358 is the same as the high-resolution resizing block 340 (FIG. 6A) except that block 358 operates on pixel aspect ratio corrected data. The color differences CFA interpolation and pixel aspect ratio correction block 354 is a combined interpolation operation. As an example, FIG. 9B (Q₁-Q_{C}) represents the CFA interpolated and pixel aspect ratio corrected version of FIG. 9A (R₁-G_{C}). Note that in FIG. 9A, each pixel value is a color difference value and not an original color value. Since pixels Q₁ and R₁ are coincident, no pixel aspect ratio correction is required for Q₁. Therefore, only CFA interpolation is performed. Standard bilinear interpolation is employed:

Q_{1R}=R₁

Q_{1G}=(G_{E}+G_{J}+G₂+G₅)/4

Q_{1B}=(B_{D}+B_{F}+B_{L}+B₆)/4

In the case of Q₂, both CFA interpolation and pixel aspect ratio correction are performed. Intermediate steps are shown to illustrate the determination of the final computation.

Q_{2R}=(2R₂+R₃)/3→(2(R₁+R₃)/2+R₃)/3→(R₁+2R₃)/3

Q_{2G}=(2G₂+G₃)/3→(2G₂+(G_{G}+G₂+G₇+G₄)/4)/3→(9G₂+G_{G}+G₇+G₄)/12

Q_{2B}=(2B₂+B₃)/3→(2(B_{F}+B₆)/2+(B_{F}+B_{H}+B₆+B₈)/4)/3→(5B_{F}+5B₆+B_{H}+B₈)/12

Therefore, the computations performed by block 354 to determine the Q₂ pixel values are:

Q_{2R}=(R₁+2R₃)/3

Q_{2G}=(9G₂+G_{C}+G₇+G₄)/12

Q_{2B}=(5B_{F}+5B₆+B_{H}+B₈)/12

The remaining computations in the example are given below.

Q_{3R}(2R₃+R_{K})/3

Q_{3G}=(9G₄+G_{G}+G₂+G₇)/12

Q_{3B}=(5B_{H}+5B₈+B_{F}+B₆)/12

Q_{4R}=(5R₁+3R₉)/8

Q_{4G}=(13G₅+G₂+G_{E}+G_{J})/16

Q_{4B}=(7B₁+7B₆+B_{D}+B_{F})/16

Q_{5R}=(10R₃+6R_{B}+5R₁+3R₉)/24

Q_{5G}=(G_{G}+15G₂+6G₅+G₄+19G₇+6G_{A})/48

Q_{5B}=(35B₆+7B₈+5B_{F}+B_{H})/48

Q_{6R}=(10R₃+6R_{B}+5R_{K}+3R_{O})/24

Q_{6G}=(G_{G}+G₂+15G₄+19G₇+6G_{M}+6G_{C})/48

Q_{6B}=(B_{F}+5B_{H}+7B₆+35B₈)/48

Q_{7R}=(R₁+3R₉)/4

Q_{7G}=(G_{A}+5G₅+G_{N}+G_{Q})/8

Q_{7B}=(3B₆+3B_{L}+B_{P}+B_{R})/8

Q_{8R}=(6R_{B}+R₁+2R₃+3R₉)/12

Q_{8G}=(11G_{A}+G_{C}+2G₂+2G₅+7G₇+G_{S})/24

Q_{8B}=(15B₆+3B₈+5B_{R}+B_{T})/24

Q_{9R}=(6R_{B}+R_{K}+3R_{O}+2R₃)/12

Q_{9G}=(G_{A}+11G_{C}+2G₄+7G₇+2G_{M}+G_{S})/24

Q_{9B}=(3B₆+15B₈+B_{R}+5B_{T})/24

Q_{AR}=(7R₉+R_{W})/8

Q_{AG}=(3G_{A}+3G₅+3G_{N}+7G_{Q})/16

Q_{AB}=(3B₆+3B_{L}+5B_{P}+5B_{R})/16

Q_{BR}=(14R_{B}+7R₉+R_{W}+2R_{Y})/24

Q_{BG}=(29G_{A}+3G_{C}+3G₇+2G_{Q}+9G_{S}+2G_{X})/48

Q_{BB}=(15B₆+3B₈+25B_{R}+5B_{T})/48

Q_{CR}=(Rₐ+14R_{B}+7R_{O}+2R_{Y})/24

Q_{CG}=(3G_{A}+29G_{C}+3G₇+9G_{S}+2G_{U}+2G_{Z})/48

Q_{CB}=(3B₆+15B₈+5B_{R}+25B_{T})/48

It will be apparent to one skilled in the art that other methods of interpolation, such as cubic convolution interpolation, can be used in place of bilinear interpolation.

FIG. 6E is a more detailed view of block 316 (FIG. 4) of an alternate embodiment. A color differences CFA interpolation and high-resolution resizing block 360 produces a high-resolution color differences image 362 from the low-resolution color differences CFA image 314 (FIG. 4). A pixel aspect ratio correction block 364 produces the corrected high-resolution color differences image 318 (FIG. 4) from the high-resolution color differences image 362.

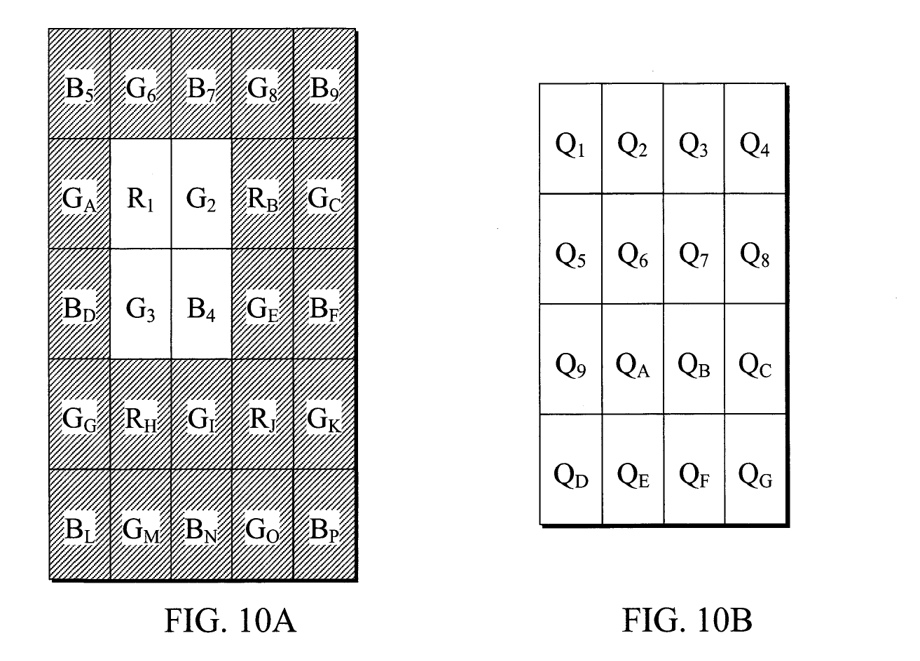

In FIG. 6E, the pixel aspect ratio correction block 364 is the same as the pixel aspect ratio correction block 344 (FIG. 6A). The color differences CFA interpolation and high-resolution resizing block 360 is a combined interpolation operation. As an example, FIG. 10B (Q₁-Q_{G}) represents the CFA interpolated and high-resolution resized version of FIG. 10A (R₁-B₄). Note that in FIG. 10A, each pixel value is a color difference value and not an original color value. Since pixels Q₁ and R₁ are coincident, no high-resolution resizing is required for Q₁. Therefore, only CFA interpolation is performed. Standard bilinear interpolation is employed:

Q_{1R}=R₁

Q_{1G}=(G₆+G_{A}+G₂+G₃)/4

Q_{1B}=(B₅+B₇+B_{D}+B₄)/4

In the case of Q₂, both CFA interpolation and high-resolution resizing are performed. Intermediate steps are shown to illustrate the determination of the final computation.

Q_{2R}=(R₁+R₂)/2→(R₁+(R₁+R_{B})/2)/2→(3R₁+R_{B})/4

Q_{2G}=(G₁+G₂)/2→((G_{A}+G₂+G₆+G₃)/4+G₂)/2→(5G₂+G_{A}+G₆+G₃)/8

Q_{2B}=(B₁+B₂)/2→((B₅+B₇+B_{D}+B₄)/4+(B₇+B₄)/2)/2→(3B₄+B₅+3B₇+B_{D})/8

Therefore, the computations performed by block 360 to determine the Q₂ pixel values are:

Q_{2R}=(3R₁+R_{B})/4

Q_{2G}=(5G₂+G_{A}+G₆+G₃)/8

Q_{2B}=(3B₄+B₅+3B₇+B_{D})/8

The remaining computations in the example are given below.

Q_{3R}=(R₁+R_{B})/2

Q_{3G}=G₂

Q_{3B}=(B₇+B₄)/2

Q_{4R}=(R₁+3R_{B})/4

Q_{4G}=(3G₂+G_{C})/4

Q_{4B}=(3B₄+B₉+3B₇+B_{F})/8

Q_{5R}=(3R₁+R_{H})/4

Q_{5G}=(G_{A}+G₂+5G₃+G₆)/8

Q_{5B}=(3B₄+B₅+B₇+3B_{D})/8

Q_{6R}=(3R_{B}+3R_{H}+R_{J}+9R₁)/16

Q_{6G}=(G_{A}+6G₂+6G₃+G₆+G_{E}+G₁)/16

Q_{6B}=(9B₄+B₅+3B₇+3B_{D})/16

Q_{7R}=(3R_{B}+R_{H}+R_{J}+3R₁)/8

Q_{7G}=(5G₂+G₃+G_{E}+G₁)/8

Q_{7B}=(3B₄+B₇)/4

Q_{8R}=(9R_{B}+R_{H}+3R_{J}+3R₁)/16

Q_{8G}=(G_{C}+6G₂+G₃+G₈+6G_{E}+G₁)/16

Q_{8B}=(9B₄+3B₇+B₉+3B_{F})/16

Q_{9R}=(R₁+R_{H})/2

Q_{9G}=G₃

Q_{9B}=(B_{D}+B₄)/2

Q_{AR}=(R_{B}+3R_{H}+R_{J}+3R₁)/8

Q_{AG}=(G₂+5G₃+G_{E}+G₁)/8

Q_{AB}=(3B₄+B_{D})/4

Q_{BR}=(R₁+R_{B}+R_{H}+R_{J})/4

Q_{BG}=(G₂+G₃+G_{E}+G₁)/4

Q_{BB}=B₄

Q_{CR}=(3R_{B}+R_{H}+3R_{J}+R₁)/8

Q_{CG}=(G₂+G₃+5G_{E}+G₁)/8

Q_{CB}=(3B₄+B_{F})/4

Q_{DR}=(3R_{H}+R₁)/4

Q_{DG}=(G_{G}+5G₃+G_{M}+G₁)/8

Q_{DB}=(3B₄+3B_{D}+B_{L}+B_{N})/8

Q_{ER}=(R_{B}+9R_{H}+3R_{J}+3R₁)/16

Q_{EG}=(G_{G}+G₂+6G₃+G_{M}+G_{E}+6G₁)/16

Q_{EB}=(9B₄+3B_{D}+B_{L}+3B_{N})/16

Q_{FR}=(R_{B}+3R_{H}+3R_{J}+R₁)/8

Q_{FG}=(G₂+G₃+G_{E}+5G₁)/8

Q_{FB}=(3B₄+B_{N})/4

Q_{GR}=(3R_{B}+3R_{H}+9R_{J}+R₁)/16

Q_{GG}=(G₂+G₃+G_{K}+G_{O}+6G_{E}+6G₁)/16

Q_{GB}=(9B₄+3B_{F}+3B_{N}+B_{P})/16

It will be apparent to one skilled in the art that other methods of interpolation, such as cubic convolution interpolation, can be used in place of bilinear interpolation.

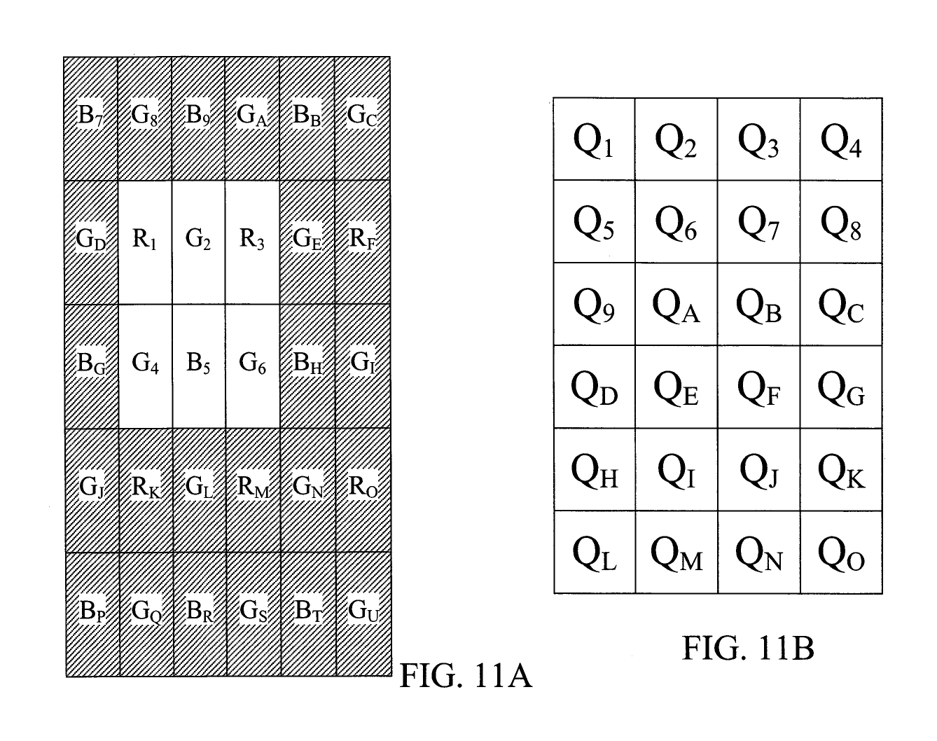

FIG. 6F is a more detailed view of block 316 (FIG. 4) of an alternate embodiment. A color differences CFA interpolation, high-resolution resizing, and pixel aspect ratio correction block 366 produces the corrected high-resolution color differences image 318 (FIG. 4) from the low-resolution color differences CFA image 314 (FIG. 4). Block 366 is a combined interpolation operation. As an example, FIG. 11B (Q₁-Q_{O}) represents the CFA interpolated, high-resolution resized, and pixel aspect ratio corrected version of FIG. 11A (R_{1 l -G}₆). Note that in FIG. 11A, each pixel value is a color difference value and not an original color value. Since pixels Q₁ and R₁ are coincident, no high-resolution resizing or pixel aspect ratio correction is required for Q₁. Therefore, only CFA interpolation is performed. Standard bilinear interpolation is employed:

Q_{1R}=R₁

Q_{1G}=(G₈+G_{D}+G₂+G₄)/4

Q_{1B}=(B₇+B₉+B_{G}+B₅)/4

In the case of Q₂, CFA interpolation, high-resolution resizing, and pixel aspect ratio correction are performed. Intermediate steps are shown to illustrate the determination of the final computation.

Q_{2R}=(R₁+3R₂)/4→(R₁+3(R₁+R₃)/2)/4→(5R₁+3R₃)/8

Q_{2G}=(G₁+3G₂)/4→((G₈+G_{D}+G₄+G₂)/4+3G₂)/4→(G_{D}+13G₂+G₄+G₈)/16

Q_{2B}=(B₁+3B₂)/4→((B₇+B₉+B_{G}+B₅)/4+(B₉+B₅)/2)/4→(7B₅+B₇+7B₉+B_{G})/16

Therefore, the computations performed by block 360 to determine the Q₂ pixel values are:

Q_{2R}=(5R₁+3R₃)/8

Q_{2G}=(G_{D}+13G₂+G₄+G₈)/16

Q_{2B}=(7B₅+B₇+7B₉+B_{G})/16

The remaining computations in the example are given below.

Q_{3R}=(R₁+3R₃)/4

Q_{3G}=(G_{A}+5G₂+G₆+G_{E})/8

Q_{3B}=(B_{B}+3B₅+3B₉+B_{H})/8

Q_{4R}=(R_{F}+7R₃)/8

Q_{4G}=(3G_{A}+3G₂+3G₆+7G_{E})/16

Q_{4B}=(5B_{B}+3B₅+3B₉+5B_{H})/16

Q_{5R}=(R_{K}+5R₁)/6

Q_{5G}=(G_{D}+G₂+3G₄+G₈)/6

Q_{5B}=(2B₅+B₇+B₉+2B_{G})/6

Q_{6R}=(5R_{K}+3R_{M}+25R₁+15R₃)/48

Q_{6G}=(2G_{D}+29G₂+9G₄+3G₆+2G₈+3G_{L})/48

Q_{6B}=(14B₅+B₇+7B₉+2B_{G})/24

Q_{7R}=(R_{K}+3R_{M}+5R₁+19R₃)/24

Q_{7G}=(2G_{A}+11G₂+G₄+7G₆+G_{L}+2G_{E})/24

Q_{7B}=(B_{B}+6B₅+3B₉+2B_{H})/12

Q_{8R}=(5R_{F}+7R_{M}+R_{O}+35R₃)/48

Q_{8G}=(6G_{A}+6G₂+19G₆+G_{N}+15G_{E}+G₁)/48

Q_{8B}=(7B_{B}+9B₅+3B₉+17B_{H})/48

Q_{9R}=(R_{K}+2R₁)/3

Q_{9G}=(G_{D}+G₂+9G₄+G₈)/12

Q_{9B}=(5B₅+B₇+B₉+5B_{G})/12

Q_{AR}=(5R_{K}+3R_{M}+10R₁+6R₃)/24

Q_{AG}=(G_{D}+19G₂+15G₄+6G₆+G₈+6G_{L})/48

Q_{AB}=(35B₅+B₇+7B₉+5B_{G})/48

Q_{BR}=(R_{K}+3R_{M}+2R₁+6R₃)/12

Q_{BG}=(G_{A}+7G₂+2G₄+11G₆+2G_{L}+G_{E})/24

Q_{BB}=(B_{B}+15B₅+3B₉+5B_{H})/24

Q_{CR}=(2R_{F}+7R_{M}+R_{O}+14R₃)/24

Q_{CG}=(3G_{A}+3G₂+29G₆+2G_{N}+9G_{E}+2G₁)/48

Q_{CB}=(5B_{B}+15B₅+3B₉+25B_{H})/48

Q_{DR}=(R₁+R_{K})/2

Q_{DG}=G₄

Q_{DB}=(B_{G}+B₅)/2

Q_{ER}=(5R_{K}+3R_{M}+5R₁+3R₃)/16

Q_{EG}=(3G₂+7G₄+3G₆+3G₁)/16

Q_{EB}=(7B₅+B_{G})/8

Q_{FR}=(R_{K}+3R_{M}+R₁+3R₃)/8

Q_{FG}=(G₂+G₄+5G₆+G₁)/8

Q_{FB}=(3B₅+B_{H})/4

Q_{GR}=(R_{F}+7R_{M}+R_{O}+7R₃)/16

Q_{GG}=(13G₆+G_{N}+G_{E}+G₁)/16

Q_{GB}=(3B₅+5B_{H})/8

Q_{HR}=(2R_{K}+R₁)/3

Q_{HG}=(9G₄+G_{J}+G₁+G_{Q})/12

Q_{HB}=(5B₅+5B_{G}+B_{P}+B_{R})/12

Q_{1R}=(10R_{K}+6R_{M}+5R₁+3R₃)/24

Q_{1G}=(6G₂+15G₄+6G₆+G_{J}+19G_{L}+G_{Q})/48

Q_{1B}=(35B₅+5B_{G}+B_{P}+7B_{R})/48

Q_{JR}=(2R_{K}+6R_{M}+R₁+3R₃)/12

Q_{JG}=(2G₂+2G₄+11G₆+7G_{L}+G_{N}+G_{S})/24

Q_{JB}=(15B₅+5B_{H}+3B_{R}+B_{T})/24

Q_{KR}=(R_{F}+14R_{M}+2R_{O}+7R₃)/24

Q_{KG}=(29G₆+3G_{L}+9G_{N}+3G_{S}+2G_{E}+2G₁)/48

Q_{KB}=(15B₅+25B_{H}+3B_{R}+5B_{T})/48

Q_{LR}=(5R_{K}+R₁)/6

Q_{LG}=(3G₄+G_{J}+G_{L}+G_{Q})/6

Q_{LB}=(2B₅+2B_{G}+B_{P}+B_{R})/6

Q_{MR}=(25R_{K}+15R_{M}+5R₁+3R₃)/48

Q_{MG}=(3G₂+9G₄+3G₆+2G_{J}+29G_{L}+2G_{Q})/48

Q_{MB}=(14B₅+2B_{G}+B_{P}+7B_{R})/24

Q_{NR}=(5R_{K}+15R_{M}+R₁+3R₃)/24

Q_{NG}=(G₃+G₄+7G₆+11G₁+2G_{N}+2G_{S})/24

Q_{NB}=(6B_{S}+2B_{H}+3B_{R}+B_{T})/12

Q_{OR}=(R_{F}+35R_{M}+5R₀+7R₃)/48

Q_{OG}=(19G₆+6G_{L}+15G_{N}+6G_{S}+G_{E}+G₁)/48

Q_{OB}=(6B₅+10B_{H}+3B_{R}+5B_{T})/24

It will be apparent to one skilled in the art that other methods of interpolation, such as cubic convolution interpolation, can be used in place of bilinear interpolation.

The pixel aspect ratio correction algorithms disclosed in the preferred embodiments of the present invention can be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

In each case, the pixel aspect ratio correction algorithms can stand alone or can be a component of a larger system solution. Furthermore, the interfaces with the algorithm, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the algorithms themselves can be fully automatic, can have user input (be fully or partially manual), can have user or operator review to accept/reject the result, or can be assisted by metadata (metadata that can be user supplied, supplied by a measuring device (e.g. in a camera), or determined by an algorithm). Moreover, the algorithms can interface with a variety of workflow user interface schemes.

The pixel aspect ratio correction algorithms disclosed herein in accordance with the invention can have interior components that utilize various data detection and reduction techniques (e.g., face detection, eye detection, skin detection, flash detection).

The invention has been described in detail with particular reference to certain preferred embodiments thereof, but it will be understood that variations and modifications can be effected within the spirit and scope of the invention.

### Parts List

110 Computer System
112 Microprocessor-based Unit
114 Display
116 Keyboard
118 Mouse
120 Selector on Display
122 Disk Drive Unit
124 Compact Disk—read Only Memory (CD-ROM)
126 Floppy Disk
127 Network Connection
128 Printer
130 Personal Computer Card (PC card)
132 PC Card Reader
134 Digital Camera
136 Camera Docking Port
138 Cable Connection
140 Wireless Connection
200 Digital Camera
202 RGB CFA Image
204 CFA Interpolation
206 Full-Color Image
208 Pixel Aspect Ratio Correction
210 Corrected Full-Color Image
212 Digital Camera
214 RGB CFA Image
216 CFA Interpolation and Resizing
218 Resized Full-Color Image
300 RGBP CFA Image
302 Panchromatic Interpolation
304 High-Resolution Panchromatic Image
306 Low-Resolution Panchromatic Image

### Parts List Cont'd

308 Color Differences Generation
310 Low-Resolution Color Decimation
312 Low-Resolution RGB CFA Image
314 Low-Resolution Color Differences CFA Image
316 Color Differences CFA Interpolation and Resizing
318 Corrected High-Resolution Color Differences Image
320 Pixel Aspect Ratio Correction
322 Corrected High-Resolution Panchromatic Image
324 Color Differences and Panchromatic Image Summation
326 Enhanced Full-Color Image
328 High-Resolution Panchromatic Interpolation
330 High-Resolution Panchromatic Image
332 Low-Resolution Panchromatic Decimation
334 Low-Resolution Panchromatic Interpolation
336 Color Differences CFA Interpolation
338 Low-Resolution Color Differences Image
340 High-Resolution Resizing
342 High-Resolution Color Differences Image
344 Pixel Aspect Ratio Correction
346 Pixel Aspect Ratio Correction
348 Corrected Color Differences Image
350 High-Resolution Resizing
352 High-Resolution Resizing and Pixel Aspect Ratio Correction
354 Color Differences CFA Interpolation and Pixel Aspect Ratio Correction
356 Corrected Low-Resolution Color Differences Image
358 High-Resolution Resizing
360 Color Differences CFA Interpolation and High-Resolution Resizing

### Parts List Cont'd

362 High-Resolution Color Differences Image
364 Pixel Aspect Ratio Correction
366 Color Differences CFA Interpolation, High-Resolution Resizing, and Pixel Aspect Ratio Correction

1. A method of forming an enhanced digital full-color image having a first pixel aspect ratio, comprising:
(a) capturing an image using an image sensor having panchromatic pixels and color pixels corresponding to at least two color photoresponses wherein color and panchromatic pixels each have a second pixel aspect ratio different from the first pixel aspect ratio;
(b) providing from the captured image a digital high-resolution panchromatic image and changing the aspect ratio of the panchromatic pixel values from the second pixel aspect ratio to the first pixel aspect ratio to produce a digital aspect corrected high-resolution panchromatic image;
(c) providing from the captured image a digital low-resolution color differences color filter array image;
(d) providing a digital aspect corrected high-resolution color differences image from the low-resolution color differences color filter array image; and
(e) using the aspect corrected high-resolution panchromatic image and an aspect corrected high-resolution color differences image to produce the enhanced digital full-color image.

2. The method of claim 1 wherein step (a) includes color pixels having the photoresponses red, green, and blue.

3. The method of claim 1 wherein step (a) includes color pixels having the photoresponses cyan, magenta, and yellow.

4. The method of claim 1, wherein step (c) includes producing a digital low-resolution panchromatic image from the high-resolution panchromatic image and using the low-resolution panchromatic image and the captured color pixels to produce the digital low-resolution color differences color filter array image.

5. The method of claim 1, wherein step (d) includes color filter array interpolating the color differences pixel values.

6. The method of claim 1, wherein step (d) includes changing the pixel aspect ratio of the color differences pixel values from the second pixel aspect ratio to the first pixel aspect ratio.

7. The method of claim 1, wherein step (d) includes resizing the color differences pixel values from low-resolution to high-resolution.

8. The method of claim 1 wherein the first pixel aspect ratio defines a square and the second pixel aspect ratio defines a non-square rectangle.
